(19) United States
(12) Patent Application Publication
(10) Pub. No.: US 2026/0249816 A1
(43) Pub. Date: Aug. 27, 2026

(54) ADAPTER FOR WINDSHIELD WIPER, WIPER DEVICE AND METHOD FOR ASSEMBLING A WINDSHIELD WIPER

(71) Applicant: VALEO SYSTEMES D'ESSUYAGE, La Verriere (FR)

(72) Inventors: Vincent GAUCHER, La Verriere (FR); Olivier JOMARD, La Verriere (FR)

(73) Assignee: VALEO SYSTEMES D'ESSUYAGE, La Verriere (FR)

(21) Appl. No.: 18/875,823

(22) PCT Filed: Jun. 19, 2023
(86) PCT No.: PCT/EP2023/066509

§ 371 Date: Dec. 17, 2024

(30) Foreign Application Priority Data
Jun. 20, 2022 (FR) FR2206019

(51) Int. Cl. B60S 1/40; B60S 1/34

(52) U.S. Cl. CPC B60S 1/4077; B60S 1/34

(57) ABSTRACT

The invention relates to an adapter for a windshield wiper including a retaining clip extended by a bracket having first and second tabs. The retaining clip being configured to clip onto the shaft end of the first or second wiper arm in such a way that in the position in which the wiper blade is joined to the first wiper arm, a first tab of the bracket slots beneath the bridge, an end wall of the bridge being inserted between the tabs of the bracket and in the position in which the wiper blade is joined to the second wiper arm, the two tabs of the bracket slot beneath the bridge.

### TECHNICAL FIELD

The present invention relates to an adapter for a windshield wiper designed to join a windshield wiper to two types of wiper arms with a lateral pivot axis. The invention also relates to a wiper device and a method for joining a windshield wiper to a first or second wiper arm.

### BACKGROUND OF THE INVENTION

Windshield wipers comprise connection means enabling them to be coupled to any actuating arm of suitable shape. It should be recalled in this respect that there are various kinds of arms, such as, for example, hook arms, arms with a lateral pivot axis, arms with longitudinal snap-fitting, etc.

Notably, two types of wiper arms with a lateral pivot axis are known. Each of the two wiper arms has a axis and a bridge intended to cooperate with a wiper or with an adapter thereof.

The pivot axiss are the same for both of these types of wiper arms. On the other hand, the bridges are different, in particular the bridge of one type of wiper arm extends further laterally than the bridge of the other type of wiper arm.

For each of these two types of arms, there is a specific adapter known as a side-lock, enabling the lateral locking of the arm to the windshield wiper. In the case of flat windshield wipers known as “FlatBlade®” wipers, these adapters wrap around the connector of the wiper to which they are fastened.

However, the adapter can be difficult to integrate in the case of an arm having an elongated bridge. Furthermore, one type of adapter must be provided for each type of arm, which is complex to manage.

### SUMMARY OF THE INVENTION

One of the objectives of the present invention is to propose a single adapter capable of cooperating with both types of wiper arms with a lateral pivot axis.

For this purpose, the invention relates to an adapter for a windshield wiper designed to join a windshield wiper to a first or a second wiper arm with a lateral pivot axis, the wiper arms having a axis and a bridge respectively, the bridge of the first wiper arm being narrower than the bridge of the second wiper arm, the adapter having a retaining clip extended at one end by a yoke having a first and a second leg, the retaining clip being designed to be snap-fitted onto the end of the axis of the first or second wiper arm so as to prevent the axial movement of the windshield wiper on the axis and so that, in the position in which the windshield wiper is joined to the first wiper arm, a first leg of the yoke is engaged under the bridge of the first wiper arm, an end wall of the bridge of the first wiper arm being inserted between the legs of the yoke, and
in the position in which the windshield wiper is joined to the second wiper arm, the two legs of the yoke are engaged under the bridge of the second wiper arm.

The adapter is snap-fitted onto the axis of the wiper arm at the end of the axis by means of the retaining clip, like a simple pin to wedge the transverse movement of the wiper along the axis. The yoke shape of the adapter and the separate wedging zones enable it to offset the differences in width of the bridge of the arms, thereby enabling the adapter to be easily joined to both types of wiper arms.

The adapter can also have one or more of the features described below, taken individually or in combination.

The first and second legs extend, for example, in respective directions parallel to each other.

In the position in which the windshield wiper is joined to the first wiper arm, the adapter for example has a wedging zone on the one hand with the windshield wiper and on the other hand with an inner surface of the end wall of the bridge of the first wiper arm.

The wedging zone with the first wiper arm may be formed by the inner face of the first leg, in the slot in the yoke.

The first leg of the yoke for example has a transverse dimension corresponding to the distance between the two wedging zones of the adapter.

An outer face of the first leg may be extended by an additional wedging surface, for example in the form of a circular segment.

In the position in which the windshield wiper is joined to the second wiper arm, the adapter may have a wedging zone on the one hand with the windshield wiper and on the other hand with an inner surface of the end wall of the bridge of the second wiper arm.

The wedging zone with the second wiper arm may be formed by the outer face of the second leg.

At least the first leg of the yoke may have a tapered end, the upper face of the first leg being inclined.

The retaining clip is for example extended at the opposite end to the yoke by a flexible stabilizing tongue designed to bear against the windshield wiper. The tongue keeps the adapter stable during use and prevents it from tilting downwards. The tongue also enables the adapter to be oriented with respect to the wiper so that the wedging zones of the adapter are correctly oriented in contact with the wiper and the arm.

The invention also relates to a wiper device characterized in that it comprises a windshield wiper and an adapter as described above.

The windshield wiper is for example a flat windshield wiper or a whippletree windshield wiper.

The invention also relates to a method for joining a windshield wiper to a first or second wiper arm, wherein:
the windshield wiper is mounted on the axis of the first or second wiper arm,
the adapter as described above is then snap-fitted onto the end of the axis to prevent the axial movement of the windshield wiper.

### BRIEF DESCRIPTION OF DRAWINGS

Other advantages and features will become clear in the following description of a specific embodiment of the invention, which is in no way limiting, and in the attached drawings, in which:

FIG. 1 is a perspective view of an example of a windshield wiper (partial view), an adapter, and a first and second wiper arm in the disassembled state.

FIG. 2A is a perspective view of the adapter in FIG. 1.

FIG. 2B is a view similar to FIG. 2A, providing another viewing angle of the adapter.

FIG. 2C is a view similar to FIG. 2A, providing another viewing angle of the adapter.

FIG. 3 is a view of the adapter in FIG. 1 during assembly of the windshield wiper with the first wiper arm.

FIG. 4 is a view after FIG. 3 in the state in which the windshield wiper is joined to the first wiper arm.

FIG. 5 is a magnified view of the assembly of the wiping device in FIG. 4.

FIG. 6 shows another viewing angle of the wiper device in FIG. 5.

FIG. 7 is a view of the adapter in FIG. 1 during assembly of the windshield wiper with the second wiper arm.

FIG. 8 is a view after FIG. 7 in the state in which the windshield wiper is joined to the second wiper arm.

FIG. 9 is a magnified view of the assembly of the wiping device in FIG. 8.

FIG. 10 shows another viewing angle of the wiper device in FIG. 9.

In these figures, identical elements are indicated using the same reference numbers.

### DETAILED DESCRIPTION OF THE INVENTION

Identical or similar elements are identified using the same reference numbers.

The following embodiments are examples. Although the description refers to one or more embodiments, this does not necessarily mean that each reference relates to the same embodiment, or that the features only apply to a single embodiment. Individual features of different embodiments can also be combined or interchanged to provide other embodiments.

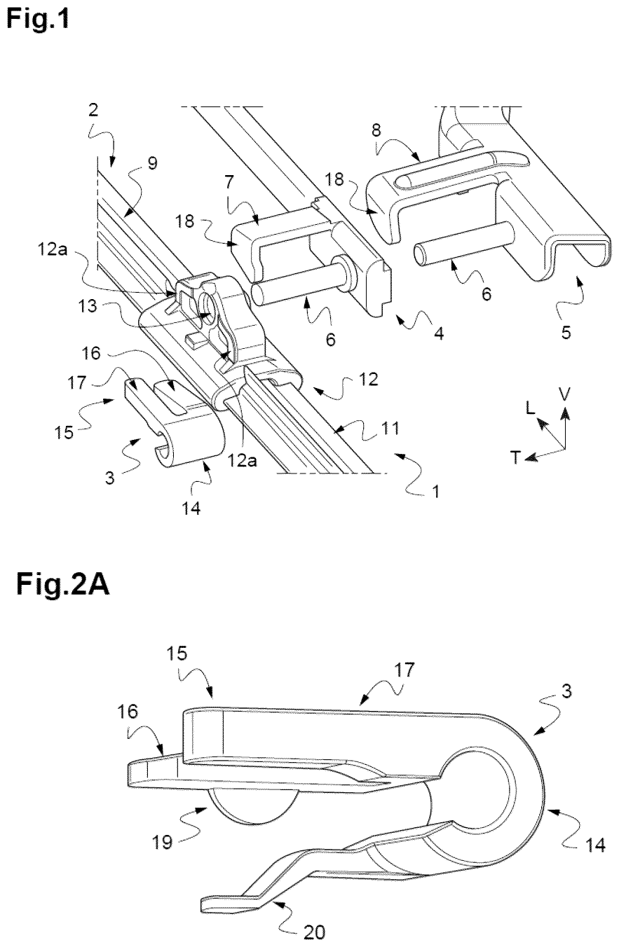

The longitudinal, vertical and transverse directions indicated in FIG. 1 by the coordinate system (L, V, T), which is static in relation to the windshield wiper, are used in the remainder of the description in a non-limiting manner. The longitudinal direction L is the main direction of the windshield wiper.

FIG. 1 shows a wiper device for a glazed surface of a vehicle, notably a windshield, comprising a windshield wiper 2 and an adapter 3 designed to join the windshield wiper 2 to a first or a second wiper arm 4, 5 with a lateral pivot axis in an articulated manner, the windshield wiper arms 4, 5 being intended to be connected to a motorized wiper mechanism of a vehicle.

The first and second windshield wiper arms 4, 5 with a lateral pivot axis have a axis 6 and a bridge 7, 8 respectively.

The axiss 6 are offset to the side of the wiper arms 4, 5. They are the same for both types of wiper arms 4, 5.

The bridges of the first and second wiper arms 4, 5 are respectively formed by an upper wall extended by an end wall curved at 90°, forming an L-shaped bridge. The upper wall extends laterally with respect to the longitudinal direction of the respective arm 4, 5, in the same direction as the axis 6, behind and above said axis if the front is considered to be oriented toward the end of the arm 4, 5 and the top is considered to be above the wiper 2.

The bridges 7, 8 of both wiper arms 4, 5 are different, specifically the bridge 7 of the first wiper arm 4 is narrower than the bridge 8 of the second wiper arm 5, i.e. the upper wall of the bridge 8 of the second wiper arm 5 extends further laterally than the upper wall of the bridge 7 of the first wiper arm 4.

In the example illustrated in the figures, the windshield wiper 2 is a flat windshield wiper known as a “FlatBlade®”. It comprises a deflector 9 (or spoiler), a wiper rubber 10 and at least one stiffening spline 11. The deflector 9 and the wiper rubber 10 are made of flexible material. The stiffening spline 11 is for example formed as a one-piece part, for example comprising a flat metal strip which is notably bent vertically, so that when the windshield wiper 2 is bearing against the glazed panel of the vehicle, the bearing forces exerted by the drive arm are distributed over the entire length of the wiper rubber 10.

The windshield wiper 2 also comprises a connector 12, arranged on top of the wiper rubber 10 and in the middle thereof. The connector 12 comprises notably a through-orifice 13 designed to receive the axis 6 of the first or second wiper arm 4, 5 so as to connect the wiper 2 to the arm 4, 5 by a pivot connection.

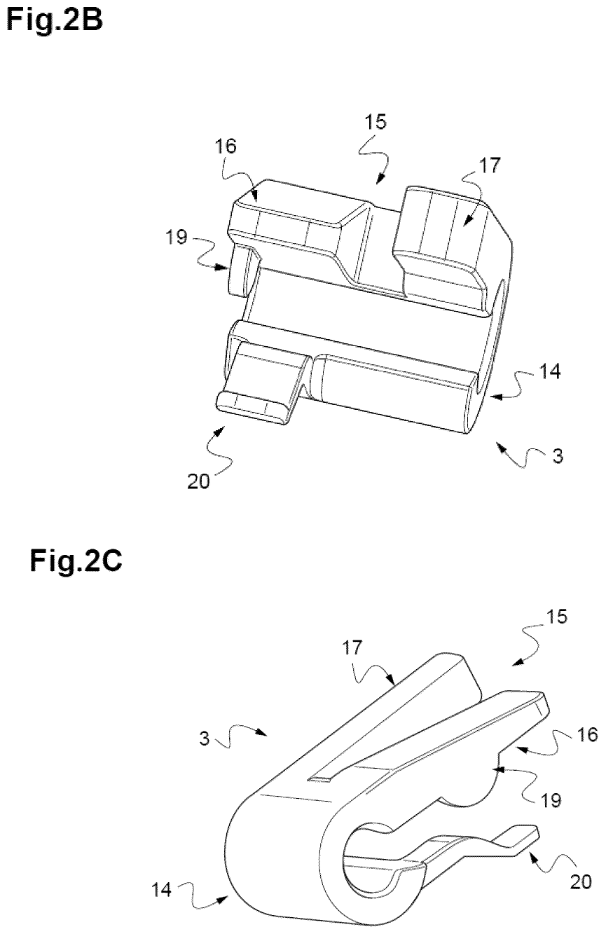

As can better be seen in FIG. 2A, FIG. 2B and FIG. 2C, the adapter 3 comprises a retaining clip 14 in the form of an open cylinder, of longitudinal C-shaped section, which can be snap-fitted (or can snap) onto the axis 6, i.e. fastened to the axis 6 by elastic deformation.

One end of the retaining clip 14 is extended by a yoke 15 having a first and a second leg 16, 17. The first and second legs 16, 17 extend, for example, in respective directions parallel to each other, such as parallel to the longitudinal direction L of the windshield wiper 2 in the position in which the windshield wiper 2 is joined to the first or second wiper arm 4, 5 (FIG. 4 and FIG. 8).

The retaining clip 14 is designed to be snap-fitted onto the end of the axis 6 of the first or second wiper arm 4, 5 so as to axially (i.e. in the transverse direction) lock the windshield wiper 2 on the wiper arm 4, 5 on the axis 6.

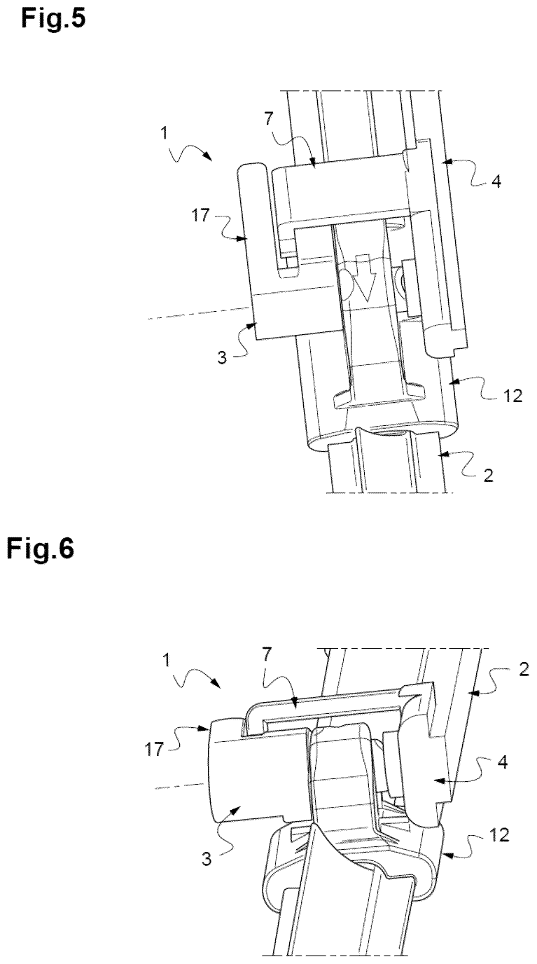

In the position in which the windshield wiper 2 is joined to the first wiper arm 4, as illustrated in FIG. 4, FIG. 5, and FIG. 6, a first leg 16 of the yoke 15 is engaged under the bridge 7 of the first wiper arm 4, the end wall 18 of the bridge 7 of the first wiper arm 4 being inserted between the legs 16, 17 of the yoke 15.

The adapter 3 has a wedging zone on the one hand with the wiper 2, in this case at the connector 12, and on the other hand with the bridge 7 of the first wiper arm 4 at the inner surface of the end wall 18 of the bridge 7.

The wedging zones are transverse contact surfaces, the functional dimensions of which are produced with small manufacturing tolerances.

On the adapter 3, the wedging zone with the wiper 2 is for example formed by an outer face of the adapter 3, and the wedging zone with the first wiper arm 4 is formed by the inner face of the first leg 16, in the slot in the yoke 15.

The outer face of the adapter 3 is a plane comprising, for example, the outer face of the first leg 16 and of the retaining clip 14, this wedging zone being in contact in this case with the ribs 12a of the connector 12.

The first leg 16 of the yoke 15 for example has a transverse dimension (or width) corresponding to the distance between these two wedging zones of the adapter 3.

The wedging zone of the adapter 3 with the wiper 2 can be increased by extending the outer face at the first leg 16 in the vertical plane (V, L) with an additional wedging surface 19, in this case having a circular-segment shape (FIG. 2C).

At least the first leg 16 of the yoke 15 for example has a tapered end (FIG. 2B). More precisely, the upper face of the first leg 16 is for example inclined toward the windshield wiper 2 with respect to the longitudinal direction L of the windshield wiper in the position in which the windshield wiper 2 is joined to the first or second wiper arm 4, 5 (FIG. 4 and FIG. 8). This ensures that the first leg 16 of the adapter 3 does not touch the upper wall of the bridge 7 of the first wiper arm 4 in the assembled position, thereby enabling the arm 4 to pivot freely (FIG. 6).

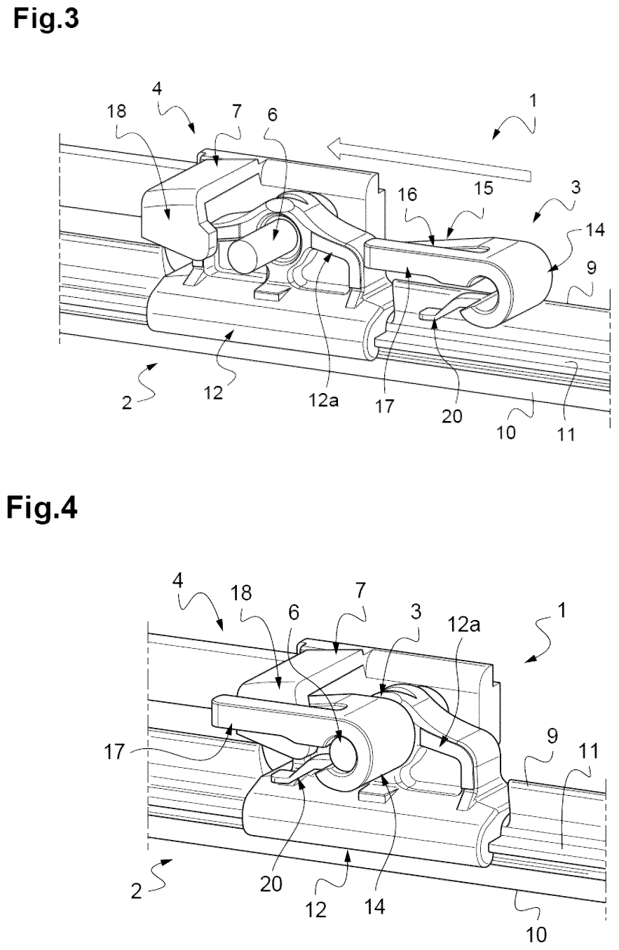

When the windshield wiper 2 is joined to the first wiper arm 4, the wiper 2 is mounted on the axis 6 of the arm 4 (FIG. 3), the adapter 3 is then snap-fitted onto the end of the axis 6 to prevent the axial movement of the windshield wiper 2, a first leg 16 of the yoke 15 being engaged under the bridge 7 of the arm 4, the end wall 18 of the bridge 7 of the first wiper arm 4 being inserted between the legs 16, 17 of the yoke 15 (FIG. 4).

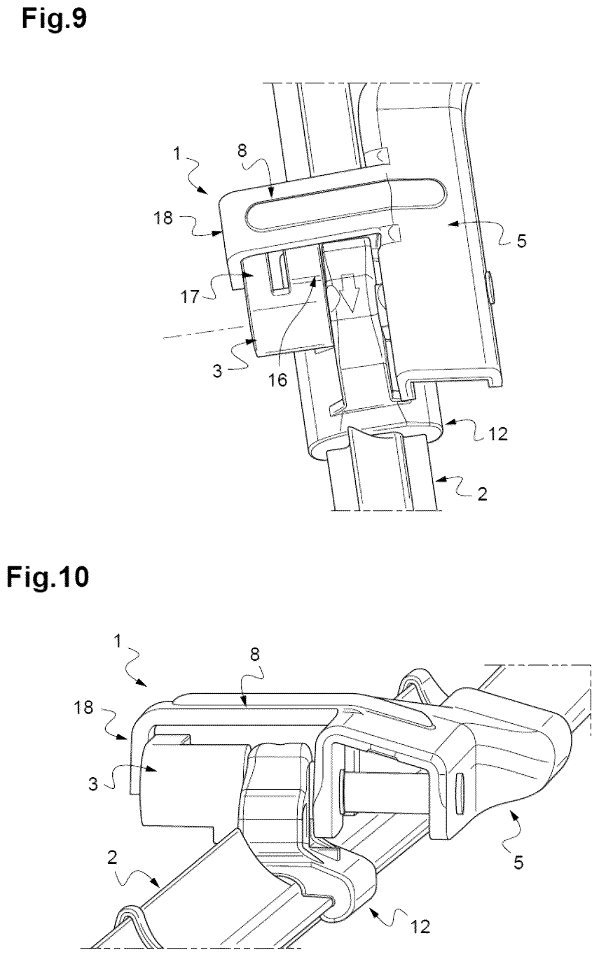

In the position in which the windshield wiper 2 is joined to the second wiper arm 5, as illustrated in FIG. 8, FIG. 9, and FIG. 10, the two legs 16, 17 of the yoke 15 are engaged under the bridge 8 of the second wiper arm 5.

The adapter 3 has a wedging zone on the one hand with the wiper 2, in this case at the connector 12, and on the other hand with the bridge 8 of the second wiper arm 5 at the inner surface of the end wall 18 of the bridge 8.

On the adapter 3, the wedging zone with the wiper 2 is still formed by the outer face of the adapter 3, and the wedging zone with the second wiper arm 5 is formed by the outer face of the second leg 17.

The second leg 17 of the yoke 15 for example has a transverse dimension (or width) corresponding to the distance between the wedging zone of the adapter 3 with the end wall 18 and the inner face of the slot in the yoke 15.

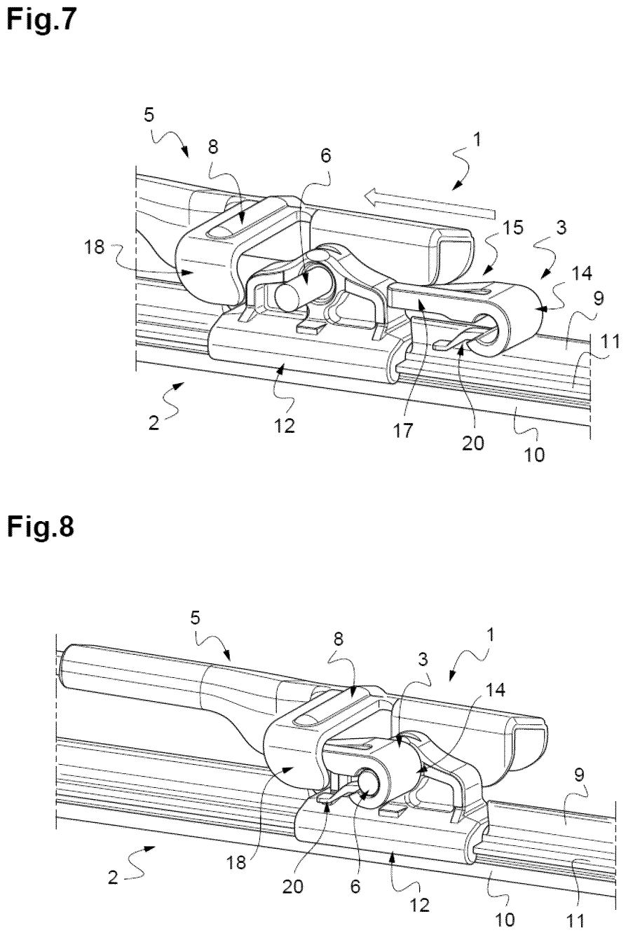

When the windshield wiper 2 is joined to the second wiper arm 5, the wiper 2 is mounted on the axis 6 of the arm 5 (FIG. 7), the adapter 3 is then snap-fitted onto the end of the axis 6 to prevent the axial movement of the windshield wiper 2, both legs 16, 17 of the yoke 15 being engaged under the bridge 8 of the arm 5 (FIG. 8).

According to one example embodiment, the retaining clip 14 is extended at the opposite end to the yoke 15 by a flexible stabilizing tongue 20 designed to bear against the windshield wiper 2. More precisely, for example, an edge of the tongue 20 bears on the connector 12 in the case of a flat windshield wiper. The tongue 20 is for example narrower than the width of the retaining clip 14 and extends longitudinally from one side of the retaining clip 14, notably the side closest to the wiper 2 in the assembled state (FIG. 2B). The tongue 20 keeps the adapter 3 stable during use and prevents it from tilting downwards. The tongue 20 also enables the adapter 3 to be oriented with respect to the wiper 2 so that the wedging zones of the adapter 3 are correctly oriented in contact with the wiper 2 and the arm 4, 5.

According to another example embodiment, the adapter 3 has no tongue and the stability of the adapter 3 on the axis 6 is ensured by a retaining clip designed to be snap-fitted onto the axis 6 less loosely than in the preceding embodiment.

The adaptor 3, i.e. the retaining clip 14, the yoke 15, and where applicable the tongue 20 and the additional wedging surface 19, is advantageously made as one piece.

The adapter 3 is snap-fitted onto the axis 6 of the wiper arm 4, 5 at the end of the axis 16 by means of the retaining clip 14, like a simple pin to wedge the transverse movement of the wiper 2 along the axis 6. The yoke shape 15 of the adapter 3 and the separate wedging zones, the inner face of the first leg 16 for the first wiper arm 4 and the outer face of the second leg 17 for the second wiper arm 4, enable the adapter to offset the differences in the width of the bridge of the arms 4, 5, enabling the adapter 3 to be easily joined to both types of wiper arms 4, 5.

Although the joining of the wiper 2 to the wiper arm 4, 5 has been described for a flat windshield wiper 2, the adapter 3 is suitable for any type of windshield wiper such as, for example, a whippletree windshield wiper.

1. An adapter for a windshield wiper designed to join a windshield wiper to a first or a second wiper arm with a lateral pivot axis, the wiper arms having an axis and a bridge respectively, the bridge of the first wiper arm being narrower than the bridge of the second wiper arm, the adapter comprising a retaining clip extended at one end by a yoke having a first and a second leg, the retaining clip being designed to be snap-fitted onto the end of the axis of the first or second wiper arm so as to prevent the axial movement of the windshield wiper on the axis and so that,
in the position in which the windshield wiper is joined to the first wiper arm, a first leg of the yoke is engaged under the bridge of the first wiper arm, an end wall of the bridge of the first wiper arm being inserted between the legs of the yoke, and
in the position in which the windshield wiper is joined to the second wiper arm, the two legs of the yoke are engaged under the bridge of the second wiper arm.

2. The adapter as claimed in claim 1, wherein the position in which the windshield wiper is joined to the first wiper arm, the adapter has a wedging zone on the one hand with the windshield wiper and on the other hand with an inner surface of the end wall of the bridge of the first wiper arm.

3. The adapter as claimed in claim 2, wherein the wedging zone with the first wiper arm is formed by the inner face of the first leg, in the slot in the yoke.

4. The adapter as claimed in claim 2, wherein the first leg of the yoke has a transverse dimension corresponding to the distance between the two wedging zones of the adapter.

5. The adapter as claimed in claim 1, wherein an outer face of the first leg is extended by an additional wedging surface.

6. The adapter as claimed in claim 5, wherein the additional wedging surface has a circular-segment shape.

7. The adapter as claimed in claim 1, wherein the position in which the windshield wiper is joined to the second wiper arm, the adapter has a wedging zone on the one hand with the windshield wiper and on the other hand with an inner surface of the end wall of the bridge of the second wiper arm.

8. The adapter as claimed in claim 7, wherein the wedging zone with the second wiper arm is formed by the outer face of the second leg.

9. A wiper wherein it comprises a windshield wiper and an adapter , the adapter including a retaining clip extended at one end by a yoke having a first and second leg, the retaining clip being designed to be a snap-fitted onto the end of the axis of the first or second wiper arm so as to prevent the axial movement of the windshield wiper on the axis and so that,
in the position in which the windshield wiper is joined to the first wiper arm, a first leg of the yoke is engaged under the bridge of the first wiper arm, an end wall of the bridge of the first wiper arm being inserted between the legs of the yoke, and
in the position in which the windshield wiper is joined to the second wiper arm, the two legs of the yoke are engaged under the bridge of the second wiper arm.

10. A method for joining a windshield wiper to a first or second wiper arm wherein:
the windshield wiper is mounted on the axis of the first or second wiper arm,
an adapter is then snap-fitted onto the end of the axis to prevent the axial movement of the windshield wiper, with the adapter including a retaining clip extended at one end by a yoke having a first and a second leg, the retaining clip being designed to be snap-fitted onto the end of the axis of the first or second wiper arm so as to prevent the axial movement of the windshield wiper on the axis and so that,
in the position in which the windshield wiper is joined to the first wiper arm, a first leg of the yoke is engaged under the bridge of the first wiper arm, an end wall of the bridge of the first wiper arm being inserted between the legs of the yoke, and
in the position in which the windshield wiper is joined to the second wiper arm, the two legs of the yoke are engaged under the bridge of the second wiper arm.
